(19) United States
(12) Patent Application Publication
(10) Pub. No.: US 2011/0103577 A1
(43) Pub. Date: May 5, 2011

(54) SESSION INITIATION PROTOCOL(SIP)-BASED MICROPHONE

(76) Inventor: DARRELL A. POIRIER, WOODSTOCK, CT (US)

(21) Appl. No.: 12/916,525

(22) Filed: Oct. 30, 2010

Related U.S. Application Data
(60) Provisional application No. 61/257,161, filed on Nov. 2, 2009.

(51) Int. Cl. H04M 1/00; H04R 11/04; G10L 15/26

(52) U.S. Cl. 379/420.03; 381/363; 704/235

(57) ABSTRACT

This invention describes a microphone that is specifically used for a multiparty conferencing system or an event recording system where people are in the same room or may be spread between separate geographical locations. The unique aspect of this directional microphone is that it can operate using network based protocols including TCP/IP, UDP, VoIP, and SIP and can enhance an event recording system by allowing the system to scale up to easily with reduced cost when compared to traditional audio microphone input channels. The microphone would fit ideally with conference recording systems as described in Poirier's U.S. Pat. Nos. 7,047,192, and 7,603,273. Poirier teaches in these patents an event recording system that separates each person's spoken statements into separate audio and/or text events based on when events start and stop.

### CROSS-REFERENCE TO RELATED APPLICATIONS

This application claims the benefit under 35 USC 119(e) of U.S. Provisional Patent Application No. 61/257,161, filed Nov. 2, 2009, all of which is hereby incorporated by reference.

### FIELD OF INVENTION

This invention concerns microphones for use in computer systems

### STATEMENT REGARDING FEDERALLY SPONSORED RESEARCH OR DEVELOPMENT

The invention has been created without the sponsorship or funding of any federally sponsored research or development program.

### REFERENCE TO SEQUENCE LISTING, A TABLE, OR A COMPUTER PROGRAM LISTING COMPACT DISK APPENDIX

Not applicable.

### DESCRIPTION

There are many types of microphones available in the market today including interfaces that support direct wiring to an analog and digital input channels, microphones that include digital to analog converters, USB serial microphones, wireless USB microphones, directional, and omni-directional, wearable microphones, and desktop microphones to name a few of the features. As is well known, microphones are used in a variety of devices including telephones, headsets, radio transmitters, embedded into computers and other devices such as GPS and plain desk top microphones.

### THE PROBLEM

While there appears to be endless types of microphones available in the present market, one area where a specific microphone is needed but there is not one available is a directional microphone that is wired or wireless that supports network protocols including TCP/IP, UDP, SIP and VoIP. Without the networking feature, traditional audio input channels become cumbersome when scaling to support high numbers of users. There are SIP conference telephones however these telephones do not meet the needs because they do not connect a specific user to a specific telephone line or channel which is advantageous when separating speech input from multiple users. Nor do typical conference telephones contain features to reduce sound to a specific audio input cone located in front of the microphone as is needed to separate out people in a conference room environment. Lacking these features has disadvantages if used in a system as described in U.S. Pat. Nos. 7,047,192, and 7,603,273 or event recording systems. A directional microphone that that also has features typically found with a telephone would be more suited for such an event recording system application.

Some of the problems encountered when creating this type of device includes:
1) Bringing specific components together that support a microphone that could connect to a conference room audio recording system including microphone components that meet the sound quality requirements, telephone transceiver features, analog telephone adapter or ATA functions to support the network protocols, and the necessary control features to support both manual and/or automated control.
2) Packaging the components together in a form factor that was small enough to be acceptable in a conference room environment.
3) Components like ATA's and quality microphones typically require a power source. Power cords become cumbersome and may take up valuable table space and should be avoided if possible. Batteries are also not desirable for permanent installations since they would need to be replaced and can leak hazardous materials that also need to be managed.
4) Unidirectional ability to provide the feature of allowing people to be sitting in a room next to each other but to have the microphone pick up audio only from the single person in front of the microphone creates another challenge.
5) To have the microphone audio output be restricted to only to the person sitting in front of the microphone
6) To allow a single audio output from remote call in attendees to be available to all people in a conference room
7) To exclude the audio from the attendees in the conference room from being echoed back into the conference room
8) The ability to scale at a reasonable cost

### BRIEF DESCRIPTION OF THE DRAWING

FIG. 1 illustrates the major components of the microphone described. In this illustration the microphone is connected to a base that contains a Microprocessor with supporting components and user interfaces.

### DETAILED DESCRIPTION

This SIP based Voice Over IP microphone would be used in a system as described by U.S. Pat. Nos. 7,047,192, and 7,603,273 or event recording systems in this way. Instead of using traditional audio equipment channels with traditional microphones, this system is based off using a telephone PBX. The advantages of using a PBX are scalability and cost reduction when compared to the traditional audio conference recording systems. Another advantage is that control of the system could be done centrally or in a distributed means by each user.

Since each microphone has ATA functionality, every microphone would be registered to the telephone PBX system, dial into the telephone conference using Session Initiated Protocol either automatically or manually.

Registration and call in could be done automatically using initialization files, web page parameters that have features to automatically connect in by dialing an extension, or a telephone keypad at each microphone. Another option may be a single button that is pressed to join the conference whereas pressing the button causes the microphone electronics and software to automatically dial the conference number similar to a memory dial on a standard telephone.

To operate the system, a typical telephone conference call would be created by a moderator and each person in the conference room would have the ability to be added to the recording.

Once all attendees have joined, participated in the conference, and the conference has ended, the recording function stops and the audio files are available for reviewing. Optionally automatic speech recognition could be added to have the conference transcribed and a small display on the microphone could present the text as it is being transcribed. The display may be a simple terminal output display with the text data being passed to the terminal via the Ethernet and TCP/IP protocol.

There could also be audio output at each microphone passed through the SIP audio channel to the ATA to the analog telephone logic with output to the speaker. The audio could be delivered to each person via a headset. The headset could also be used for language translation during the conference. Alternatively there could be a small output speaker at each microphone providing audio to the conference room from remote attendees. Audio from microphones inside the conference room would be filter out from audio output at each microphone in the room. This would avoid negative affects such as audio feedback and delayed audio from attendees speaking in the room. Filtering out audio could be accomplished by intercepting and removing network packets from specific TCP/IP addresses or specific port numbers being used as audio output for example. Another option would be to have no output speakers on each microphone but instead to have an output speaker separate from the microphones located in the conference room where attendees are located.

The microphones could be connected by a network medium like category 5 network wire. In this configuration power over Ethernet switches could be used to supply power to the microphone and related electronics. Alternatively the microphones could be a wireless network configuration using batteries for power. This configuration may be more desirable if setting up to record a conference at a single event single location and then to move to recording another event at a different time and location.

An Event Recording System as described by Poirier in U.S. Pat. Nos. 7,047,192, and 7,603,273 could be setup on a mobile PC (Laptop) with a wireless router or access point and a software PBX as are well know in the VOIP industry. The microphones would then connect via the wireless access point to the PBX which the event recording system is also connected to. Alternatively the microphones could connect directly to the event recording system using SIP or a peer to peer model like Skype or General Voice's Kontext peer to peer event recording system.

### Solutions to the Problems Listed Above:

### Specific Components Needed:

Power supply, power management or converters, an audio preamp that adjusts microphone voltage levels to telephone handset circuit levels, control features like a telephone keypad, software initialization files, an enclosure that meets physical aspects for form factor and weighting, and microphone with sufficient audio quality, and optionally a display output with a display driver circuit and a microprocessor capable of connecting Ethernet with TCP/IP and related software to present the text on the display.

### Preamp

Pre-amplification is achieved by incorporating an audio preamp between the microphone and the analog telephone receiver where the handset microphone is typically connected. The preamp also provides circuit balancing as required by some types of microphones. The audio preamp should have a gain control potentiometer to enable adjustments to be made to acquire the best audio input results.

### Power Requirements

This is achieved by adding a battery as the power source for the electric microphone. Alternatively power from the ATA power supply may be used but in most cases the voltage and/or current requirements do not match the microphone requirements so an additional voltage conversion and regulation circuit may be required. DC to DC converters are well known and will not be described here. If using “Power over Ethernet” supplied from a network switch maximum power rating per switch and compatible voltages may again be require for both the ATA and the microphone. The same is true to power the optional microprocessor with the display.

### Isolation of Attendees Speaking

The goal is to take audio input from a narrow directional cone that filters out sound that's not directly in front of the microphone. Unidirectional ability provides the feature of allowing people to be sitting in a room next to each other and to have the microphone pick up audio only from the person in front of the microphone, There are different methods to achieved this affect, one is by adding a focusing tube over the end of a unidirectional microphone creating a narrow tunnel where sound can enter. Another option would be to adjust the audio gain on a unidirectional microphone to a minimum working level. A combination of the tube and the audio gain adjustment could also be used.

### Form Factor

The typical desktop microphone form factor would allow users to have familiarity with such a device and potentially not require special training to operate the device.

Moreover, if the microphone has a standard telephone keypad with traditional buttons including mute this would also reduce the training need.

Specific features of the microphone could include:
1. A wired or wireless network connection that supports:
   a. Network speeds including 10 megabit, 100 megabit, and 1 Gigabit network speeds
   b. DCHP and static addressing network addressing
2. Support for the following SIP features:
   a. SIP protocol stack
   b. Web page, or audio messages to configure SIP parameters including at least:
      i. IP configuration
      ii. SIP registration
      iii. Dial-out calling
      iv. SIP port selection
      v. Logging features for SIP connection
3. Telephone type key pad (numbers 1 through 0 with # and *)
4. Small speaker for audio output with speaker mute button
5. Microphone mute button
6. Headphone connector
7. Power over Ethernet capability
8. G711 and G729 codec support (Programmable feature to allow other voice codecs to be added)
9. Directional microphone that filters out sound outside of a 24 inch cone in front of the microphone
10. Sufficient base weighted for stability with a flexible gooseneck microphone
11. Automatic mute that activates when there is no sound directly in front of the microphone
12. Wireless base that supports the features listed above, enabling the microphone itself to be wireless, for example Bluetooth could be one option
13. Electronics that will support the functionality listed above
14. Software that will support the functionality listed above

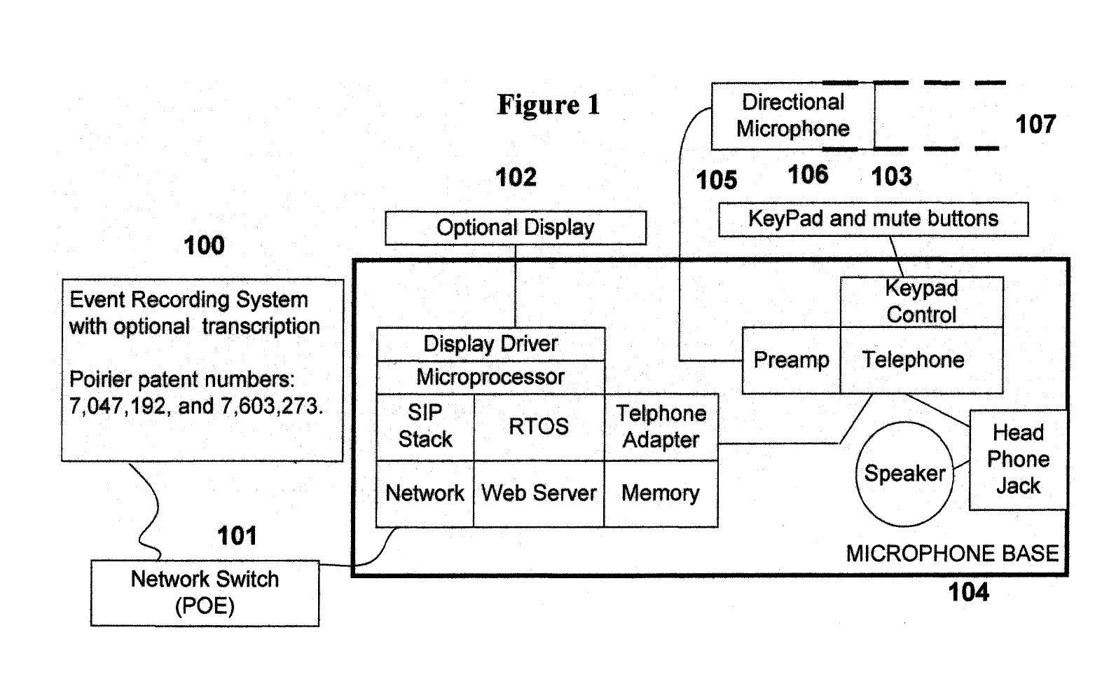

FIG. 1 illustrates the major components of the microphone described. In this illustration the microphone is connected to a base that contains a Microprocessor with supporting components and user interfaces.

Referring to FIG. 1, an Event Recording System (100) as described by U.S. Pat. Nos. 7,047,192 and 7,603,273 connects to a network switch (101) which also has a connection to one or more SIP microphones (104). The SIP microphone (104) includes the functional components for network interface, web server, telephone adapter, telephone circuitry, microprocessor, memory, preamp, keypad, optional speaker, microphone, headphone jack, optional speaker, and optional display driver and display. The microphone (106) has an extended tunnel (107) to limit sound input from each side of the microphone is on a gooseneck extender (105). Not shown in the picture is an optional battery, power over Ethernet, and wireless features which are well know in the electronics, telephone, and computer industries.

1) A SIP Microphone that is specifically used for a multiparty conferencing and/or recording system or an event recording system that contains the following features:
a. Network connection
b. Microprocessor with memory and operating code with functionality to connect to a network
c. TCP, UDP, and SIP network protocol functionality
d. Keypad for joining a conference
e. Analog telephone adapter circuit with coding features for configuration files, a web page user interface, a network connection, and an analog telephone connection, and an optional automatic dialing feature
f. Analog telephone circuit with a microphone input, a speaker output, and a telephone keypad
g. Audio preamp circuit
h. Unidirectional microphone on a gooseneck stand
i. Optional microphone audio filter tunnel or electronic audio filter control
j. Optional speaker and/or headphone output
k. Optional display output
l. Optional microphone mute key
m. Optional speaker mute key

2) A microphone as described in claim 1 that can join an audio conference by connecting to a PBX telephone system that uses the Session Initiated Protocol (SIP)

3) A microphone as described in claim 1 that can join an audio conference by connecting to a PBX telephone system that uses the Session Initiated Protocol (SIP) that has a single button for connecting to an audio conference.

4) A microphone as described in claim 1 that can join an audio conference by connecting to a PBX telephone system that uses the Session Initiated Protocol (SIP) that can automatically connect to an audio conference.

5) A microphone as described in claim 1 that can join an audio conference by connecting to a PBX telephone system that uses the Session Initiated Protocol (SIP) and is very directional filtering out sound on each side of the microphone.

6) A microphone as described in claim 1 that can join an audio conference by connecting to a PBX telephone system that uses the Session Initiated Protocol (SIP) that can be controlled to join a conference from a separate and/or central location.

7) A microphone as described in claim 1 that can join an audio conference by connecting to a PBX telephone system that uses the Session Initiated Protocol (SIP) that can show transcribed text on a display.

8) A microphone as described in claim 1 that can join an audio conference by connecting to a PBX telephone system that uses the Session Initiated Protocol (SIP) that can provide audio output language translated from a remote location.
